(19) United States
(12) Patent Application Publication
(10) Pub. No.: US 2017/0344718 A1
(43) Pub. Date: Nov. 30, 2017

(54) SYSTEMS, APPARATUS, AND METHODS FOR A MEDICAL DEVICE COMMUNICATION BRIDGE

(71) Applicant: ASCENSIA DIABETES CARE HOLDINGS AG, Basel (CH)

(72) Inventor: Jun Chen, Warren, NJ (US)

(21) Appl. No.: 15/608,980

(22) Filed: May 30, 2017

Related U.S. Application Data
(60) Provisional application No. 62/343,841, filed on May 31, 2016.

(51) Int. Cl. G06F 19/00

(52) U.S. Cl. CPC G06F 19/3418; G06F 19/3468; G06F 19/323

(57) ABSTRACT

Embodiments of the present invention provide systems, apparatus, and methods for a medical device communication bridge. A medical device communication bridge can include a processor coupled to a memory, the memory operative to store a plurality of software modules including instructions executable on the processor; a first interface for coupling an output port of an existing government authority registered and approved medical device to the processor to enable the processor to receive measurement data from the medical device; a second interface for coupling a patient identification system to the processor to receive patient identification information associated with the measurement data; and a communications transceiver coupled to the processor and operable to transmit output information to a hospital network, the output information determined by the processor executing one or more of the software modules based on the measurement data and the patient identification information. Numerous additional aspects are disclosed.

### RELATED APPLICATIONS

The present application claims priority to U.S. Provisional Patent Application No. 62/343,841 filed May 31, 2016, and entitled “SYSTEMS, APPARATUS, AND METHODS FOR A MEDICAL DEVICE COMMUNICATION BRIDGE” (Attorney Docket No. BHC154010(BHDD-087/L)) which is hereby incorporated herein by reference in its entirety for all purposes.

### FIELD

The present invention relates to medical devices, and more specifically to systems, apparatus, and methods for a medical device communication bridge.

### BACKGROUND

Management of diabetes involves large amounts of diagnostic data and prescriptive data that are acquired from medical devices, personal healthcare devices, patient recorded information, healthcare professional tests results, prescribed medications and recorded information. Medical devices include self-monitoring blood glucose meters, continuous glucose monitors, ambulatory insulin infusion pumps, diabetes analysis software, and diabetes device configuration software each of which generates or manages or both large amounts of diagnostic and prescriptive data. Personal healthcare devices include weight scales, pedometers and blood pressure cuffs. Patient recorded information includes information relating to meals, exercise and lifestyle as well as prescription and non-prescription medications. Healthcare professional biomarker data includes HbA1C, fasting glucose, cholesterol, triglycerides and glucose tolerance. Healthcare professional recorded information includes therapy and other information relating to the patient's treatment.

There is a need for a device to aggregate, manipulate, manage, present, and communicate diagnostic data and prescriptive data from medical devices, personal healthcare devices, patient recorded information, biomarker information and recorded information in an efficient manner to improve the care and health of a person with diabetes, so the person with diabetes can lead a full life and reduce the risk of complications from diabetes. Thus, what is needed are improved systems, apparatus, and methods for a medical device communication bridge.

### SUMMARY

In some embodiments, the present invention provides a medical device communication bridge. A medical device communication bridge can include a processor coupled to a memory, the memory operative to store a plurality of software modules including instructions executable on the processor; a first interface for coupling an output port of an existing government authority registered and approved medical device to the processor to enable the processor to receive measurement data from the medical device; a second interface for coupling a patient identification system to the processor to receive patient identification information associated with the measurement data; and a communications transceiver coupled to the processor and operable to transmit output information to a hospital network, the output information determined by the processor executing one or more of the software modules based on the measurement data and the patient identification information.

In some other embodiments, the present invention provides a medical device communication bridge system. The medical device communication bridge system can include a government authority registered and approved medical device having a wired output port; a patient identification system; a medical device communication bridge including a processor coupled to a memory, the memory operative to store a plurality of software modules including instructions executable on the processor, a first interface for coupling to the wired output port of the medical device to the processor to enable the processor to receive measurement data from the medical device, a second interface for coupling the patient identification system to the processor to receive patient identification information associated with the measurement data, and a communications transceiver coupled to the processor and operable to transmit output information determined by the processor executing one or more of the software modules based on the measurement data and the patient identification information; a hospital network coupled to the communications transceiver; and a smartphone coupled to the communications transceiver.

In yet other embodiments, the present invention provide methods for using a medical device communication bridge. The methods can include providing a government authority registered and approved medical device; receiving measurement data from the medical device via a signal on wired connection; receiving patient identification information via an identification system; associating the measurement data with the patient identification information; performing processing using a plurality of software modules executing on a processor based on the measurement data and the patient identification information; and communicating processing results to a hospital network via a transceiver coupled to the processor.

Still other features, aspects, and advantages of the present invention will become more fully apparent from the following detailed description, the appended claims, and the accompanying drawings by illustrating a number of exemplary embodiments and implementations, including the best mode contemplated for carrying out the present invention. Embodiments of the present invention may also be capable of other and different applications, and its several details may be modified in various respects, all without departing from the spirit and scope of the present invention. Accordingly, the drawings and descriptions are to be regarded as illustrative in nature, and not as restrictive. The drawings are not necessarily drawn to scale. The description is intended to cover all modifications, equivalents, and alternatives falling within the spirit and scope of the claims.

### BRIEF DESCRIPTION OF THE DRAWINGS

FIG. 1 is a schematic block diagram depicting an example of a medical device communication bridge system according to embodiments of the present invention.

FIG. 2 is a schematic block diagram depicting an example medical device communication bridge according to embodiments of the present invention.

FIG. 3 is a flowchart illustrating an example method of using a medical device communication bridge according to embodiments of the present invention.

### DETAILED DESCRIPTION

Embodiments of the present invention provide systems, apparatus, and methods for a medical device communication bridge. The process for registering and getting medical devices approved for use by the appropriate government authority in various jurisdictions around the world is an expensive and time consuming process. In addition, any change made to a registered and approved medical device typically requires re-registering and re-approval of the device to insure the original operation is not negatively affected, which is also costly and time consuming. Advances in diabetes care and management technology have yielded blood glucose meters (BGMs) that include advanced functions such as a bolus calculator, a patient insulin guideline generator, and an insulin delivery algorithm for controlling an insulin pump. However, adding these features to existing BGM designs is expensive and takes a long time due to the requirement to re-register and to get re-approved. Embodiment of the present invention provides a cost effective solution to this problem. Embodiments provide a medical device communication bridge that allows existing government authority registered and approved medical devices such as a BGM with an output port to be used with advanced functions such as a bolus calculator, a patient insulin guideline generator, and an insulin delivery algorithm for controlling an insulin pump.

Embodiments of the present invention create a wireless bridge between BGMs without wireless capabilities and various wireless devices or networks. Embodiments enable automated processing of measured data received from an existing BGM or other registered and approved medical device to provide drug (e.g., insulin) guidelines to the user, as well as utilizing bolus calculations for drug delivery devices such as insulin pumps. Further, embodiment of the present invention enable receiving and processing of patient identification information in, for example, hospitals via utilization of an identification systems such as an ID bracelet barcode scanner and/or radio frequency identification (RFID) module. In some embodiments, a medical device communication bridge can be used in bio-sensor networks that are adapted to acquire patient information (e.g., heart rate, biomarker data, diagnostic data, and prescriptive data) measured from the patient or received from other devices, distributed over a mesh network.

Typically, the majority of conventional BGMs that are registered and approved by an appropriate government authority do not include advanced features such as a bolus calculator, an insulin guideline generator, drug delivery system command generator, or even wireless capabilities that allow utilization of these meters in systems that include smart devices (e.g., smartphones) or wireless networks (e.g., in hospitals or health care provider (HCP) offices). Currently, the majority of insulin users use pre-filled syringes. These patients typically do not have the access to embedded bolus calculator software that can be a part of an expensive insulin pump user interface. Such patients have to calculate the insulin dose manually. Embodiments of the present invention provide patients with the above advanced features (e.g., wireless capability, bolus calculator, and insulin guidelines) without having to have an expensive, high end BGM or insulin pump.

Further, embodiments provide a bridge function from basic BGMs to hospital wireless networks that allows integration and use of basic approved BGMs in hospital networks which require patient identification information that the conventional basic BGMs do not provide. Typically, basic BGMs include a serial communication port that allows the user to upload BG data (e.g., measurement results) to a personal computer (PC). Frequently, BGM manufacturers provide a special cable (e.g., a serial to USB) and special software for such data transfers. Using this output port, embodiments of the present invention provide a communication bridge that can couple to the output port to facilitate two-way wireless communication with smart devices (e.g., smartphones, tablets, etc.) and hospital networks.

Further, software modules embedded in the medical device communications bridge enable reliable processing of BG measurement data and providing the user with insulin usage guidelines without requiring the BGM to perform calculations or relying on an application running on a smartphone to perform the calculations. In other words, embodiments of the present invention provide a stable, reliable platform for processing medical data that is both external to the BGM and not vulnerable to the myriad complexities and ever changing nature of a smartphone which is subject to other applications. Thus, embodiments of the present invention provide users with the ability to use reduced cost BGMs and reduced cost self-administered syringes but still have the benefit of an automated, reliable, and stable bolus calculator with output to any smart device.

In addition to BG test result data, the data received from a BGM also includes meal markers and other information that are taken into account in conjunction with the BG test result data. The software modules of embodiments of the present invention can calculate a next dose of insulin for a user to inject. In use in a hospital or HCP office environment, embodiment of a medical device communication bridge can associate and provide patient identification data to insure that the medication is administered to the correct patient.

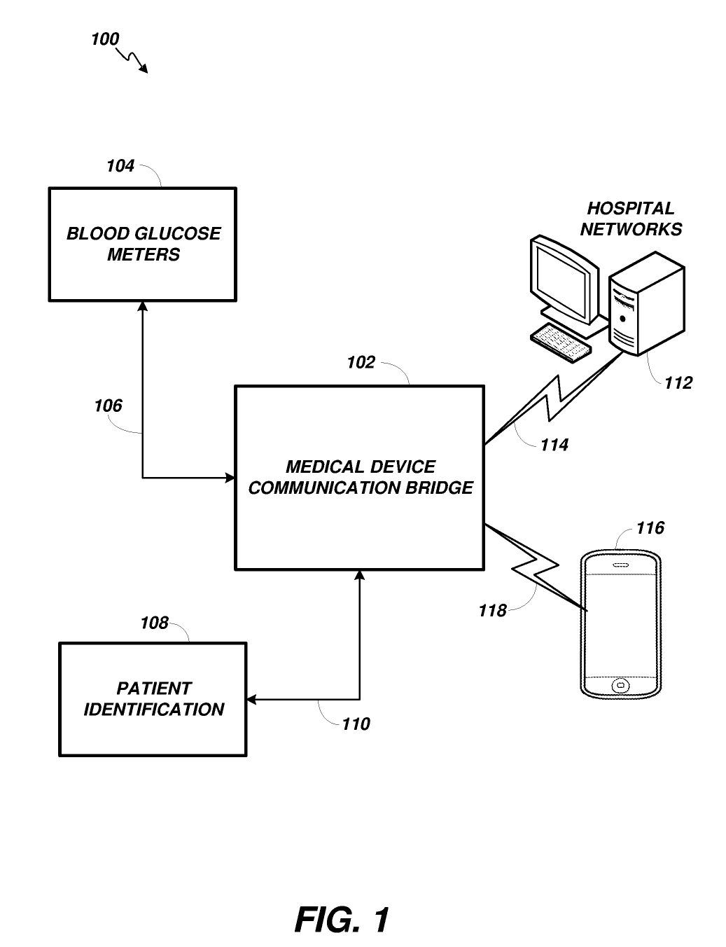

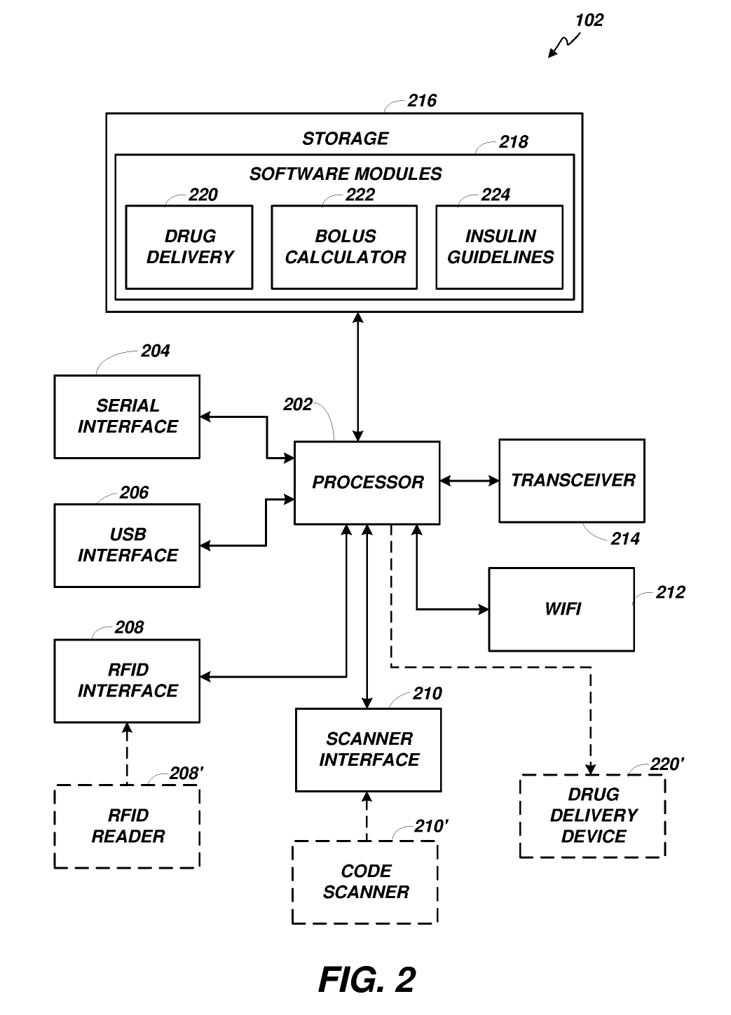

Turning now to FIG. 1, an example of a medical device communication bridge system 100 according to embodiments of the present invention is shown. The system 100 includes a medical device communication bridge 102 (described in detail below with respect to FIG. 2) coupled to a plurality of other devices. The coupled devices include blood glucose meters 104 registered and approved by an appropriate government authority. The blood glucose meters 104 include an output port that can be used to couple the blood glucose meters 104 to the medical device communication bridge 102 via a serial or USB cable 106.

The coupled devices can further include a patient identification system 108 that can be coupled to the medical device communication bridge 102 via a wired or wireless connection 110. The coupled devices can further include a hospital network 112 (e.g., a LAN with one or more servers and other devices storing patient data and other information) that can be coupled to the medical device communication bridge 102 via a wired or wireless connection 114.

The coupled devices can further include patient or HCP smart devices 116 (e.g., smartphone, tablet, smartwatch, etc.) that can be coupled to the medical device communication bridge 102 via a wired or wireless connection 118. Although not shown in FIG. 1, the coupled devices can further include mesh or other networks (e.g., on-body, sub-dermal, bed, or worn sensor networks) that can be coupled to the medical device communication bridge 102 via a wired or wireless connection.

FIG. 2 depicts an example of a medical device communication bridge 102 according to embodiments of the present invention. The medical device communication bridge 102 includes a processor 202 (e.g., a computer processor such as a microprocessor, controller, or a programmable gate array operable to execute instructions) that is coupled to a number of other devices. The other devices can include a serial interface 204, a USB interface 206, an identification system interface (e.g., an RFID interface 208 and/or a scanner interface 210), a communications transceiver (e.g., a WIFI transceiver 212 and/or a LAN transceiver 214), and a storage device 216 which can include memories (e.g., ROM and RAM), solid state drives, hard drives, secure digital cards, and/or the like.

The storage device 216 can include a plurality of software modules 218 stored within, which, in addition to an operating system (not shown) and operating program (not shown), can include a drug delivery module 220 for generating commands to operate an optional drug delivery device 220′ (shown in phantom), a bolus calculator module 222 for calculating dosage for a drug administration (either manually via syringe, or automatically via a drug infuser (e.g., the optional drug delivery device 220′)) and an insulin guidelines module 224 for generating messages to patients regarding usage of insulin based on measured data from blood glucose meters 104 and patient identification data received from the identification system 108.

In some embodiments, the medical device communication bridge 102 can include (or be coupled to) an RFID reader 208′ (shown in phantom) via the RFID interface 208 and a code scanner 210′ (shown in phantom) (e.g., a barcode, QR-code, etc. reader) via the scanner interface. Although a number of specific connections and configurations are shown, any number of alternative connections and configurations that are practicable can be used. For example, the drug delivery device 220′ can be coupled to the processor 202 via the WIFI transceiver 212 or other interface in some embodiments. Likewise, in some embodiments, the scanner interface 210 can be embodied as a Bluetooth® transceiver for example that pairs with a code scanner 210′. In some embodiments, other communications interfaces/protocols such as near field communication (NFC), ZigBee (IEEE 802.15.4), Bluetooth® low energy (BLE), etc. can be used to connect the various devices as suitable and practicable.

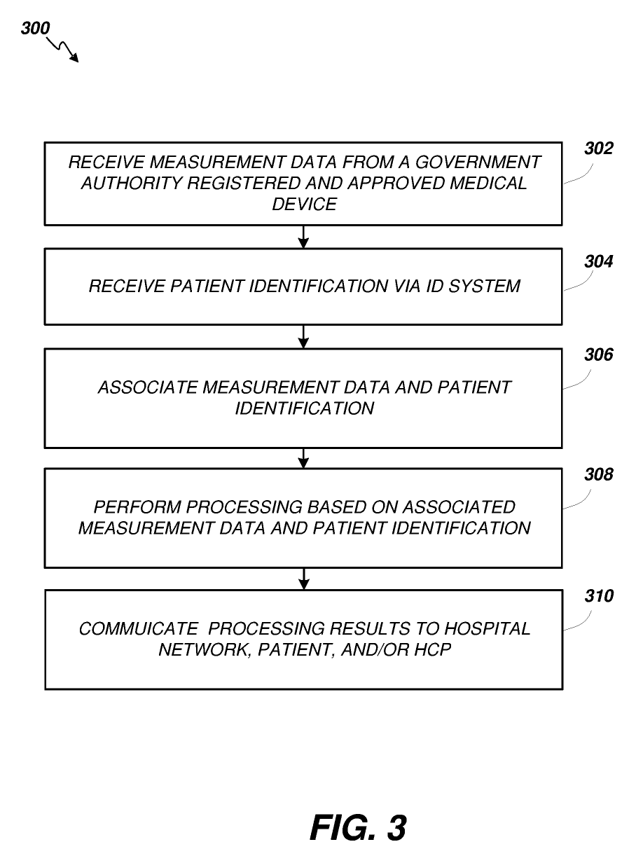

In operation, embodiments of the medical device communication bridge 102 can be used to allow patients to use reduced cost, existing BGMs and reduced cost self-administered syringes with the benefit of an automated, reliable, and stable bolus calculator with output to any smart device. As shown in FIG. 3, an example method 300 of using a medical device communication bridge 102 can include a number of steps. Although a specific number of steps are illustrated, it will be understood that any number of additional, alternative, or fewer steps can be included. Likewise, although a specific order is depicted, it will be understood that any practicable order can be used to implement the method 300 of embodiments of the present invention.

The example method 300 includes receiving measurement and other data from a medical device (302). Advantageously, the medical device can be an existing, inexpensive, basic device that has been registered and approved for use in the relevant jurisdiction by the appropriate government or other authority. Notably, use with the system 100 of embodiments of the present invention does not alter in anyway the medical device and thus, does not call into question the registration and approval of the medical device. The measurement and other data is received via an output port of the medical device. For example, the output port can be a serial port or a USB port or any other practicable wired output port.

Along with the measurement and other data from the medical device, patient identification data is received from the identification system (304). As discussed above, the identification system can include an RFID reader and/or a code scanner. The system 100 then stores and associates the measurement data and the patient identification data (306).

Using one or more of the software modules 218 discussed above, the associated measurement data and the patient identification data are processed to determine, for example, such information as drug delivery instructions, drug dosage, and drug usage guidelines (308). In some embodiments, additional information retrieved or received from a hospital network, from an HCP server/smart device, from the patient's smart device, and/or from direct input (e.g., via input buttons on the medical device communication bridge itself) can be used as input for the software modules 218. The processing results from the software modules 218 is then communicated to the hospital network via the communication transceiver and/or to the patient and/or the HCP via smart devices (310).

Numerous embodiments are described in this disclosure, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features of the invention that must be present in all embodiments.

The Title (set forth at the beginning of the first page of this disclosure) is not to be taken as limiting in any way as the scope of the disclosed invention(s).

The term “product” means any machine, manufacture and/or composition of matter as contemplated by 35 U.S.C. §101, unless expressly specified otherwise.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “and/or”, when such term is used to modify a list of things or possibilities (such as an enumerated list of possibilities) means that any combination of one or more of the things or possibilities is intended, such that while in some embodiments any single one of the things or possibilities may be sufficient in other embodiments two or more (or even each of) the things or possibilities in the list may be preferred, unless expressly specified otherwise. Thus for example, a list of “a, b and/or c” means that any of the following interpretations would be appropriate: (i) each of “a”, “b” and “c”; (ii) “a” and “b”; (iii) “a” and “c”; (iv) “b” and “c”; (v) only “a”; (vi) only “b”; and (vii) only “c.”

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

Each process (whether called a method, algorithm or otherwise) inherently includes one or more steps, and therefore all references to a “step” or “steps” of a process have an inherent antecedent basis in the mere recitation of the term ‘process’ or a like term. Accordingly, any reference in a claim to a ‘step’ or ‘steps’ of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device, component or article is described herein, more than one device, component or article (whether or not they cooperate) may alternatively be used in place of the single device, component or article that is described. Accordingly, the functionality that is described as being possessed by a device may alternatively be possessed by more than one device, component or article (whether or not they cooperate).

Similarly, where more than one device, component or article is described herein (whether or not they cooperate), a single device, component or article may alternatively be used in place of the more than one device, component or article that is described. For example, a plurality of computer-based devices may be substituted with a single computer-based device. Accordingly, the various functionality that is described as being possessed by more than one device, component or article may alternatively be possessed by a single device, component or article.

The functionality and/or the features of a single device that is described may be alternatively embodied by one or more other devices that are described but are not explicitly described as having such functionality and/or features. Thus, other embodiments need not include the described device itself, but rather can include the one or more other devices which would, in those other embodiments, have such functionality/features.

Devices that are in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for weeks at a time. In addition, devices that are in communication with each other may communicate directly or indirectly through one or more intermediaries.

A description of an embodiment with several components or features does not imply that all or even any of such components and/or features are required. On the contrary, a variety of optional components are described to illustrate the wide variety of possible embodiments of the present invention(s). Unless otherwise specified explicitly, no component and/or feature is essential or required.

Further, although process steps, algorithms or the like may be described in a sequential order, such processes may be configured to work in different orders. In other words, any sequence or order of steps that may be explicitly described does not necessarily indicate a requirement that the steps be performed in that order. The steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not indicate that all or even any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

An enumerated list of items (which may or may not be numbered) does not imply that any or all of the items are mutually exclusive, unless expressly specified otherwise. Likewise, an enumerated list of items (which may or may not be numbered) does not imply that any or all of the items are comprehensive of any category, unless expressly specified otherwise. For example, the enumerated list “a computer, a laptop, a PDA” does not imply that any or all of the three items of that list are mutually exclusive and does not imply that any or all of the three items of that list are comprehensive of any category.

Headings of sections provided in this disclosure are for convenience only, and are not to be taken as limiting the disclosure in any way.

“Determining” something can be performed in a variety of manners and therefore the term “determining” (and like terms) includes calculating, computing, deriving, looking up (e.g., in a table, database or data structure), ascertaining, recognizing, and the like.

A “display” as that term is used herein is an area that conveys information to a viewer. The information may be dynamic, in which case, an LCD, LED, CRT, Digital Light Processing (DLP), rear projection, front projection, or the like may be used to form the display. The aspect ratio of the display may be 4:3, 16:9, or the like. Furthermore, the resolution of the display may be any appropriate resolution such as 480i, 480p, 720p, 1080i, 1080p or the like. The format of information sent to the display may be any appropriate format such as Standard Definition Television (SDTV), Enhanced Definition TV (EDTV), High Definition TV (HDTV), or the like. The information may likewise be static, in which case, painted glass may be used to form the display. Note that static information may be presented on a display capable of displaying dynamic information if desired. Some displays may be interactive and may include touch screen features or associated keypads as is well understood.

The present disclosure may refer to a “control system” or program. A control system or program, as that term is used herein, may be a computer processor coupled with an operating system, device drivers, and appropriate programs (collectively “software”) with instructions to provide the functionality described for the control system. The software is stored in an associated memory device (sometimes referred to as a computer readable medium). While it is contemplated that an appropriately programmed general purpose computer or computing device may be used, it is also contemplated that hard-wired circuitry or custom hardware (e.g., an application specific integrated circuit (ASIC)) may be used in place of, or in combination with, software instructions for implementation of the processes of various embodiments. Thus, embodiments are not limited to any specific combination of hardware and software.

A “processor” means any one or more microprocessors, Central Processing Unit (CPU) devices, computing devices, microcontrollers, digital signal processors, or like devices. Exemplary processors are the INTEL PENTIUM or AMD ATHLON processors.

The term “computer-readable medium” refers to any statutory medium that participates in providing data (e.g., instructions) that may be read by a computer, a processor or a like device. Such a medium may take many forms, including but not limited to non-volatile media, volatile media, and specific statutory types of transmission media. Non-volatile media include, for example, optical or magnetic disks and other persistent memory. Volatile media include DRAM, which typically constitutes the main memory. Statutory types of transmission media include coaxial cables, copper wire and fiber optics, including the wires that comprise a system bus coupled to the processor. Common forms of computer-readable media include, for example, a floppy disk, a flexible disk, hard disk, magnetic tape, any other magnetic medium, a CD-ROM, Digital Video Disc (DVD), any other optical medium, punch cards, paper tape, any other physical medium with patterns of holes, a RAM, a PROM, an EPROM, a FLASH-EEPROM, a USB memory stick, a dongle, any other memory chip or cartridge, a carrier wave, or any other medium from which a computer can read. The terms “computer-readable memory” and/or “tangible media” specifically exclude signals, waves, and wave forms or other intangible or non-transitory media that may nevertheless be readable by a computer.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols. For a more exhaustive list of protocols, the term “network” is defined below and includes many exemplary protocols that are also applicable here.

It will be readily apparent that the various methods and algorithms described herein may be implemented by a control system and/or the instructions of the software may be designed to carry out the processes of the present invention.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models, hierarchical electronic file structures, and/or distributed databases) could be used to store and manipulate the data types described herein. Likewise, object methods or behaviors of a database can be used to implement various processes, such as those described herein. In addition, the databases may, in a known manner, be stored locally or remotely from a device that accesses data in such a database. Furthermore, while unified databases may be contemplated, it is also possible that the databases may be distributed and/or duplicated amongst a variety of devices.

As used herein a “network” is an environment wherein one or more computing devices may communicate with one another. Such devices may communicate directly or indirectly, via a wired or wireless medium such as the Internet, LAN, WAN or Ethernet (or IEEE 802.3), Token Ring, or via any appropriate communications means or combination of communications means. Exemplary protocols include but are not limited to: Bluetooth™, Time Division Multiple Access (TDMA), Code Division Multiple Access (CDMA), Global System for Mobile communications (GSM), Enhanced Data rates for GSM Evolution (EDGE), General Packet Radio Service (GPRS), Wideband CDMA (WCDMA), Advanced Mobile Phone System (AMPS), Digital AMPS (D-AMPS), IEEE 802.11 (WI-FI), IEEE 802.3, SAP, the best of breed (BOB), system to system (S2S), or the like. Note that if video signals or large files are being sent over the network, a broadband network may be used to alleviate delays associated with the transfer of such large files, however, such is not strictly required. Each of the devices is adapted to communicate on such a communication means. Any number and type of machines may be in communication via the network. Where the network is the Internet, communications over the Internet may be through a website maintained by a computer on a remote server or over an online data network including commercial online service providers, bulletin board systems, and the like. In yet other embodiments, the devices may communicate with one another over RF, cable TV, satellite links, and the like. Where appropriate encryption or other security measures such as logins and passwords may be provided to protect proprietary or confidential information.

Communication among computers and devices may be encrypted to insure privacy and prevent fraud in any of a variety of ways well known in the art. Appropriate cryptographic protocols for bolstering system security are described in Schneier, APPLIED CRYPTOGRAPHY, PROTOCOLS, ALGORITHMS, AND SOURCE CODE IN C, John Wiley & Sons, Inc. 2d ed., 1996, which is incorporated by reference in its entirety.

It will be readily apparent that the various methods and algorithms described herein may be implemented by, e.g., appropriately programmed general purpose computers and computing devices. Typically a processor (e.g., one or more microprocessors) will receive instructions from a memory or like device, and execute those instructions, thereby performing one or more processes defined by those instructions. Further, programs that implement such methods and algorithms may be stored and transmitted using a variety of media (e.g., computer readable media) in a number of manners. In some embodiments, hard-wired circuitry or custom hardware may be used in place of, or in combination with, software instructions for implementation of the processes of various embodiments. Thus, embodiments are not limited to any specific combination of hardware and software. Accordingly, a description of a process likewise describes at least one apparatus for performing the process, and likewise describes at least one computer-readable medium and/or memory for performing the process. The apparatus that performs the process can include components and devices (e.g., a processor, input and output devices) appropriate to perform the process. A computer-readable medium can store program elements appropriate to perform the method.

The present disclosure provides, to one of ordinary skill in the art, an enabling description of several embodiments and/or inventions. Some of these embodiments and/or inventions may not be claimed in the present application, but may nevertheless be claimed in one or more continuing applications that claim the benefit of priority of the present application. Applicants intend to file additional applications to pursue patents for subject matter that has been disclosed and enabled but not claimed in the present application.

The foregoing description discloses only example embodiments of the invention. Modifications of the above-disclosed apparatus, systems and methods which fall within the scope of the invention will be readily apparent to those of ordinary skill in the art.

Accordingly, while the present invention has been disclosed in connection with exemplary embodiments thereof, it should be understood that other embodiments may fall within the spirit and scope of the invention, as defined by the following claims.

The invention claimed is:

1. A medical device communication bridge comprising:
a processor coupled to a memory, the memory operative to store a plurality of software modules including instructions executable on the processor;
a first interface for coupling an output port of an existing government authority registered and approved medical device to the processor to enable the processor to receive measurement data from the medical device;
a second interface for coupling a patient identification system to the processor to receive patient identification information associated with the measurement data; and
a communications transceiver coupled to the processor and operable to transmit output information to a hospital network, the output information determined by the processor executing one or more of the software modules based on the measurement data and the patient identification information.

2. The medical device communication bridge of claim 1 wherein the plurality of software modules include at least one of a drug delivery module operable to generate operating commands for a drug delivery device, a bolus calculator module operable to determine dosage instructions based on the measurement data, and an insulin guideline module operable to provide a patient with insulin guidelines via a smartphone.

3. The medical device communication bridge of claim 1 wherein the first interface includes at least one of a serial interface and a universal serial bus (USB) interface.

4. The medical device communication bridge of claim 1 wherein the second interface includes at least one of a radio frequency identification (RFID) interface and a scanner interface.

5. The medical device communication bridge of claim 1 wherein the communications transceiver includes at least one of a local area network (LAN) transceiver and a WIFI transceiver.

6. The medical device communication bridge of claim 1 wherein the communications transceiver is further operable to transmit output information to a patient smartphone.

7. The medical device communication bridge of claim 1 wherein the software modules include instructions executable on the processor to cause the processor to retrieve patient information from the hospital network via the communications transceiver for use in execution of the software modules.

8. A medical device communication bridge system comprising:
a government authority registered and approved medical device having a wired output port;
a patient identification system;
a medical device communication bridge including a processor coupled to a memory, the memory operative to store a plurality of software modules including instructions executable on the processor, a first interface for coupling to the wired output port of the medical device to the processor to enable the processor to receive measurement data from the medical device, a second interface for coupling the patient identification system to the processor to receive patient identification information associated with the measurement data, and a communications transceiver coupled to the processor and operable to transmit output information determined by the processor executing one or more of the software modules based on the measurement data and the patient identification information;
a hospital network coupled to the communications transceiver; and
a smartphone coupled to the communications transceiver.

9. The system of claim 8 wherein the plurality of software modules include at least one of a drug delivery module operable to generate operating commands for a drug delivery device, a bolus calculator module operable to determine dosage instructions based on the measurement data, and an insulin guideline module operable to provide a patient with insulin guidelines via a smartphone.

10. The system of claim 8 wherein the first interface includes at least one of a serial interface and a universal serial bus (USB) interface and the medical device includes a blood glucose meter.

11. The system of claim 8 wherein the second interface includes at least one of a radio frequency identification (RFID) interface and a scanner interface and the identification system includes at least one of an RFID reader and a barcode scanner.

12. The system of claim 8 wherein the communications transceiver includes at least one of a local area network (LAN) transceiver and a WIFI transceiver. transceiver is further operable to transmit output information to the smartphone.

14. The system of claim 8 wherein the software modules include instructions executable on the processor to cause the processor to retrieve patient information from the hospital network via the communications transceiver for use in execution of the software modules.

15. A method for using a medical device communication bridge, the method comprising:
providing a government authority registered and approved medical device;
receiving measurement data from the medical device via a signal on wired connection;
receiving patient identification information via an identification system;
associating the measurement data with the patient identification information;
performing processing using a plurality of software modules executing on a processor based on the measurement data and the patient identification information; and
communicating processing results to a hospital network via a transceiver coupled to the processor.

16. The method of claim 15 wherein providing a government authority registered and approved medical device includes providing a blood glucose meter having at least one of a serial output port and a universal serial bus (USB) output port.

17. The method of claim 15 wherein receiving patient identification information includes receiving patient identification information from at least one of a radio frequency identification (RFID) reader via an RFID interface and a barcode scanner via a scanner interface.

18. The method of claim 15 wherein performing processing using a plurality of software modules includes generating operating commands for a drug delivery device via a drug delivery module.

19. The method of claim 15 wherein performing processing using a plurality of software modules includes determining dosage instructions based on the measurement data via a bolus calculator module.

20. The method of claim 15 wherein performing processing using a plurality of software modules includes providing a patient with insulin guidelines via a smartphone using an insulin guideline module.
